(19) United States
(12) Patent Application Publication
(10) Pub. No.: US 2016/0274793 A1
(43) Pub. Date: Sep. 22, 2016

(54) STORAGE APPARATUS, STORAGE CONTROL METHOD, AND COMPUTER-READABLE RECORDING MEDIUM FOR RECORDING STORAGE CONTROL PROGRAM

(71) Applicant: NEC Corporation, Tokyo (JP)

(72) Inventor: Sadahide OASHI, Tokyo (JP)

(73) Assignee: NEC Corporation

(21) Appl. No.: 15/044,262

(22) Filed: Feb. 16, 2016

(30) Foreign Application Priority Data
Mar. 19, 2015 (JP) 2015-055891

(51) Int. Cl. G06F 3/06

(52) U.S. Cl. CPC G06F 3/065; G06F 3/0619; G06F 3/064; G06F 3/0683

(57) ABSTRACT

A storage apparatus including a communication control unit that aggregates an oldest writing clock time for each of a plurality of storage units from a plurality of a retained pieces of information each relating to a writing clock time, calculates, for each of the plurality of storage units, a priority level having a positive correlation with a time difference between the aggregated oldest writing clock time and a predetermined reference clock time, assigns, to each of the plurality of storage units, a transmission bandwidth for transmission of at least one retained block of write data for each of the plurality of storage units among a plurality of the retained blocks of write data based on the calculated priority level, and transmits, for each of the plurality of storage units, the at least one retained block of write data to an external backup apparatus in accordance with the assigned transmission bandwidth.

This application is based upon and claims the benefit of priority from Japanese Patent Application No. 2015-055891, filed on Mar. 19, 2015, the disclosure of which is incorporated herein in its entirety by reference.

### TECHNICAL FIELD

The present invention relates to storage apparatuses, storage control methods, and computer-readable recording media for recording a storage control program and, in particular, it relates to a storage apparatus, a storage control method, and a computer-readable recording medium for recording a storage control program for recording a storage control program, which suppress the increase of a recovery point objective in a backup apparatus.

### BACKGROUND ART

Recently, with the increase of the importance of disaster countermeasures, a case where electronic data is transmitted from a main site to a remote site that is geographically located far from the main site in order to back up the electronic data has been increasing. With respect to large scale systems, there are also lots of cases where a system similar to that of a main site is installed in a remote site and thereby a redundant system is established. In such a case, it is required to ensure the data consistency between data stored in the main site and backup data stored in the remote site.

An example of a technology for ensuring the data consistency of the backup data is disclosed in PTL 1.

A remote copy system disclosed in PTL 1 includes a main center and a remote center. The main center includes a plurality of disk subsystems. The remote center includes disk subsystems each associated with a corresponding one of the disk subsystems of the main center. Each of the disk subsystems of the main center is communicably connected to a corresponding one of the disk subsystems via an interface cable. Each of the disk subsystems includes disk storage devices.

The remote copy system disclosed in PTL 1 operates as follows. First, the disk subsystem of the main center writes blocks of data into the disk storage devices included in the disk subsystem and simultaneously therewith gives a sequential number and a clock time to each of the blocks of data. Next, the disk subsystem of the main center transmits the blocks of data to a corresponding disk subsystem of the remote center. Next, the disk subsystem of the remote center arranges received blocks of data in order in accordance with sequential numbers given to the received blocks of data, and determines an oldest clock time among newest clock times each given to a certain block of data stored in a corresponding one of the subsystems of the remote center through communication with the other disk subsystems thereof. Next, the disk subsystem of the remote center makes blocks of data each having a clock time earlier than the determined oldest clock time a target of data writing into the disk storage devices.

As a result of the above operation, in the remote copy system disclosed in PTL 1, all blocks of data that have been written earlier than a specific clock time in the main center are written into the disk storage devices of the remote center. Accordingly, in the remote copy system disclosed in PTL 1, the data consistency between the blocks of data having been written into the disk storage devices of the remote center is ensured.

Further, if a loss of backup data occurs in communication between a main site and a remote site, there occurs a case where blocks of backup data at a desired time point are not retained in the remote site. In particular, in a system like a cloud system, it is difficult to predict an amount of data to be written into each of storage apparatuses. Thus, it is difficult to, in a communication line connected to a remote site, assign a required bandwidth to each the storage apparatuses in advance at the time of a system design. Accordingly, it is required to reduce the occurrence of the loss of backup data that is transmitted to the remote site.

An example of technologies for reducing the occurrence of the loss of backup date that is transmitted to the remote site is disclosed in PTL 2.

An information processing system disclosed in PTL 2 includes a plurality of copy-source storage systems, a plurality of copy-destination storage systems, a communication line, and an administrative computer. Each of the copy-source storage systems includes a storage and a cache. Each of the copy-source storage systems stores update information into the storage, and stores the update information in the cache until the update information is transmitted to the copy-destination storage systems. The copy-destination storage systems store therein replicas of data having been stored in the plurality of copy-source storage systems. The communication line is used for data transmission from the copy-source storage systems to the copy-destination storage systems. The administrative computer controls the copy-source storage systems.

The information processing system disclosed in PTL 2 operates as follows. First, the administrative computer acquires a usage rate of the cache of each of the copy-source storage systems. Next, the administrative computer assigns a larger portion of a bandwidth of the communication line to a copy-source storage system having a high usage rate of the cache, and assigns a smaller portion of the bandwidth of the communication line to a copy-source storage system having a low usage rate of the cache.

As a result of the above operation, in the information processing system disclosed in PTL 2, the amount of data transmitted from the copy-source storage system having a high usage rate of the cache becomes larger, and the amount of data transmitted from the copy-source storage system having a low usage rate of the cache becomes smaller. Accordingly, in the information processing system disclosed in PTL 2, the possibility in that the cache of a certain copy-source storage system overflows although the cache of another copy-source storage system has a sufficient storage room is reduced.

By the way, if a failure of data in a main site has occurred, it is desirable that the data is restored by using backup data in a remote site at a time point as near as possible a time point of a last update of original data in the main site. A time difference between a time point at which writing of original data is performed at a main site and a time point at which backing up of corresponding data is completed at a remote site is called “a recovery point objective”. This recovery point objective is also called “RPO” or “a recovery point”. For example, if the RPO is zero seconds, it is always possible to perform restoring to newest data. If the RPO is one day, it is possible to perform restoring to data at a time point one day before.

Further, if a plurality of storage apparatuses having data related to one another exists in one system, in order to ensure data consistency in the system, it is necessary to handle an RPO relating to a storage apparatus and being larger than an RPO relating to any other one of the storage apparatuses as an RPO as the whole of the system. That is, the RPO as the whole of the system corresponds to an RPO relating to a storage apparatus in which a time point of transmitting data to the remote site is later than that in any other one of the storage apparatuses.

In the technologies disclosed in PTL 1 and PTL 2, there is a problem in that, if a speed of generation of data to be written into a storage apparatus temporarily exceeds the bandwidth of a communication line connected to a backup apparatus, it is difficult to suppress the increase of an RPO.

An example of technologies for suppressing the increase of an RPO in case that the speed of generation of data to be written into a storage apparatus temporarily exceeds the bandwidth of a communication line connected to a backup apparatus is disclosed in PTL 3.

A storage system disclosed in PTL 3 includes a primary storage apparatus and a secondary storage apparatus.

The primary storage apparatus provides a first volume for writing/reading data to/from an upper-layer apparatus. The primary storage apparatus includes at least one storage device and a journal generation portion. The journal generation portion sets a plurality of first groups each including the first volume. The journal generation portion is configured to, for each of the first groups having been set, upon writing of data into the first volume, generate a journal including the data and a time stamp indicating a clock time of the writing of the data.

The secondary storage apparatus provides a second volume for use in replicating the data having been written into the first volume. The secondary storage apparatus includes at least one storage device, a journal acquisition reflection portion, a time difference detection portion, and a journal acquisition control portion. The journal acquisition reflection portion sets second groups each including the second volume such that each of the second groups is associated with a corresponding one of the first groups. The journal acquisition reflection portion is configured to, for each of the second groups having been set, acquire the journals from the primary storage apparatus at constant intervals in order in which the journals have been generated. Further, the journal acquisition reflection portion reflects the acquired journals into a relevant second volume in a relevant second group.

The storage system disclosed in PTL 3 operates as follows.

First, the time difference detection portion compares newest time stamps each relating to a corresponding one of the second groups and being included in one of journals that are retained in a state of being not reflected into the second volume of the relevant second group, and thereby detects a time difference between the newest one of the compared newest time stamps and the oldest one of the compared newest time stamps.

Next, in the case where the detected time difference exceeds a preset threshold value, the journal acquisition control portion causes only journals of a second group having the detected oldest time stamp to be acquired until the amount of acquired journals reaches a preset predetermined amount, and brings the acquisition of the journals of any other one of the second groups to a halt.

As a result of the above operation, in the storage system disclosed in PTL 3, the acquisition of the journals of the second group having the oldest time stamp is prioritized. Accordingly, in the storage system disclosed in PTL 3, in case that the speed of generation of data to be written into a storage apparatus temporarily exceeds the bandwidth of a communication line connected to a backup apparatus, the increase of the RPO of data contained in the second group having the oldest time stamp is suppressed.

### CITATION LIST

### Patent Literature

[PTL 1] Japanese Unexamined Patent Application Publication No. 2001-282628

[PTL 2] Japanese Unexamined Patent Application Publication No. 2006-059260

[PTL 3] Japanese Unexamined Patent Application Publication No. 2009-123055

### SUMMARY

### Technical Problem

In the storage system disclosed in PTL 3, in the case where a time difference relating to the newest time stamps each relating to a corresponding one of the second groups exceeds a preset threshold value, the acquisition of the journals of each of second groups other than a second group having the oldest one of the relevant newest time stamps is brought to a halt until the amount of acquired journals reaches a preset predetermined amount. That is, in the storage system disclosed in PTL 3, in the case where a time difference related to the newest time stamps each relating to a corresponding one of the second groups exceeds a preset threshold value, the RPO of data contained in each of second groups other than the second group having the oldest one of the relevant newest time stamps increases until the amount of acquired journals reaches a preset predetermined amount. It does not necessarily mean, however, the suppression of increase of the RPO of the whole of a system that only the RPO of data contained in the second group having the oldest one of the newest time stamps is decreased although, during a period of the decrease of the relevant RPO, the RPO of data contained in each of second groups other than the relevant second group increases. Accordingly, in the storage system disclosed in PTL 3, there is a problem in that the effect of suppressing the increase of an RPO is insufficient when the speed of generation of data to be written into a storage apparatus temporarily exceeds the bandwidth of a communication line connected to a backup apparatus.

### OBJECT OF INVENTION

A main object of the present invention is that a storage apparatus, a storage control method, and a computer-readable recording medium for recording a storage control program are provided, which make it possible to, even if the speed of generation of write data to be written into a storage apparatus temporarily exceeds the bandwidth of a communication line connected to a backup apparatus, suppress the increase of a recovery point objective.

### Solution to Problem

A storage apparatus according to a first aspect of the present invention includes a plurality of storage unit; a data retaining unit that temporarily retains a block of write data that is written into one of the plurality of storage units, a piece of information relating to a writing destination of the block of write data, and a piece of information relating to a writing clock time of the block of write data, until the retained block of write data is transmitted to an external backup apparatus; and a communication control unit that aggregates an oldest writing clock time for each of the plurality of storage units from a plurality of the retained pieces of information each relating to the writing clock time, calculates, for each of the plurality of storage units, a priority level having a positive correlation with a time difference between the aggregated oldest writing clock time and a predetermined reference clock time, assigns, to each of the plurality of storage units, a transmission bandwidth for transmission of at least one retained block of write data for each of the plurality of storage units among a plurality of the retained blocks of write data based on the calculated priority level, and transmits, for each of the plurality of storage units, the at least one retained block of write data to the external backup apparatus in accordance with the assigned transmission bandwidth.

A storage control method according to a second aspect of the present invention includes temporarily retaining a block of write data that is written into one of a plurality of storage units, a piece of information relating to a writing destination of the block of write data, and a piece of information relating to a writing clock time of the block of write data, until the retained block of write data is transmitted to an external backup apparatus; aggregating an oldest writing clock time for each of the plurality of storage units from a plurality of the retained pieces of information each relating to the writing clock time; calculating, for each of the plurality of storage units, a priority level having a positive correlation with a time difference between the aggregated oldest writing clock time and a predetermined reference clock time; assigning, to each of the plurality of storage units, a transmission bandwidth for transmission of at least one retained block of write data for each of the plurality of storage units among a plurality of the retained blocks of write data based on the calculated priority level; and transmitting, for each of the plurality of storage units, the at least one retained block of write data to the external backup apparatus in accordance with the assigned transmission bandwidth.

A computer-readable recording medium for recording a storage control program, according to a third aspect of the present invention, stores therein a storage control program that causes a computer to execute processing including a data retaining process of temporarily retaining a block of write data that is written into one of a plurality of storage units, a piece of information relating to a writing destination of the block of write data, and a piece of information relating to a writing clock time of the block of write data, until the retained block of write data is transmitted to an external backup apparatus; and a communication control process of aggregating an oldest writing clock time for each of the plurality of storage units from a plurality of the retained pieces of information each relating to the writing clock time, calculating, for each of the plurality of storage units, a priority level having a positive correlation with a time difference between the aggregated oldest writing clock time and a predetermined reference clock time, assigning, to each of the plurality of storage units, a transmission bandwidth for transmission of at least one retained block of write data for each of the plurality of storage units among a plurality of the retained blocks of write data based on the calculated priority level, and transmitting, for each of the plurality of storage units, the at least one retained block of write data to the external backup apparatus in accordance with the assigned transmission bandwidth.

### Advantageous Effects of Invention

The present invention brings about an advantageous effect in that, even if the speed of generation of write data to be written into a storage apparatus temporarily exceeds the bandwidth of a communication line connected to a backup apparatus, the increase of a recovery point objective can be suppressed.

### BRIEF DESCRIPTION OF THE DRAWINGS

FIG. 1 is a block diagram illustrating an example of the configuration of a storage apparatus according to a first exemplary embodiment of the present invention.

FIG. 2 is a flowchart illustrating the operation of a storage apparatus according to a first exemplary embodiment of the present invention.

FIG. 3A is a diagram that describes specific examples of processing performed by a storage apparatus according to a first exemplary embodiment of the present invention.

FIG. 3B is a diagram that describes specific examples of processing performed by a storage apparatus according to a first exemplary embodiment of the present invention.

FIG. 3C is a diagram that describes specific examples of processing performed by a storage apparatus according to a first exemplary embodiment of the present invention.

FIG. 3D is a diagram that describes specific examples of processing performed by a storage apparatus according to a first exemplary embodiment of the present invention.

FIG. 4A is a diagram that describes specific examples of processing performed by a storage apparatus that is a comparison example.

FIG. 4B is a diagram that describes specific examples of processing performed by a storage apparatus that is a comparison example.

FIG. 4C is a diagram that describes specific examples of processing performed by a storage apparatus that is a comparison example.

FIG. 4D is a diagram that describes specific examples of processing performed by a storage apparatus that is a comparison example.

FIG. 5A is a flowchart illustrating the operation of a storage apparatus according to second and third exemplary embodiments of the present invention.

FIG. 5B is a flowchart illustrating the operation of a storage apparatus according to second and third exemplary embodiments of the present invention.

FIG. 6 is a block diagram illustrating an example of the configuration of a storage apparatus according to a fourth exemplary embodiment of the present invention.

FIG. 7 is a block diagram illustrating an example of the detailed configuration of a main site according to a fourth exemplary embodiment of the present invention.

FIG. 8 is a diagram illustrating an example of a transmission speed management table of a main site, according to a fourth exemplary embodiment of the present invention.

FIG. 9 is a diagram illustrating an example of a buffer memory management table of a main site, according to a fourth exemplary embodiment of the present invention.

FIG. 10 is a flowchart illustrating the operation of a main site in case that the main site has received write data from one of hosts, according to a fourth exemplary embodiment of the present invention.

FIG. 11 is a flowchart illustrating the operation of data transmission to a remote site by a main site, according to a fourth exemplary embodiment of the present invention.

FIG. 12 is a flowchart illustrating the operation of data transmission speed control by a main site, according to a fourth exemplary embodiment of the present invention.

### EXEMPLARY EMBODIMENT

Hereinafter, exemplary embodiments according to the present invention will be described in detail with reference to the drawings. In addition, in all of the drawings, similar constituent elements are denoted by the same reference sign, and description thereof will be appropriately omitted.

### First Exemplary Embodiment

The configuration of this exemplary embodiment will be described below.

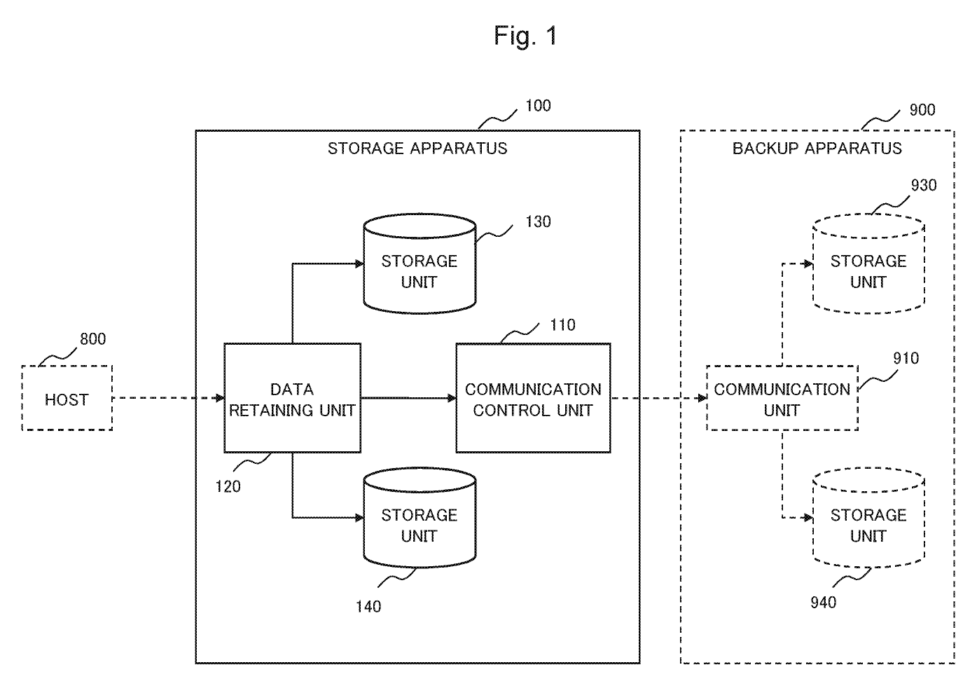

FIG. 1 is a block diagram illustrating an example of the configuration of a storage apparatus 100 according to this first exemplary embodiment of the present invention.

The storage apparatus 100 according to this exemplary embodiment receives write data from an external host 800, and stores the received write data therein. Further, the storage apparatus 100 transmits the write data to an external backup apparatus 900 via a communication line. In addition, the transmission bandwidth (i.e., the transmission speed) of the communication line has a predetermined upper limit value (hereinafter, referred to as an “upper limit bandwidth”).

The backup apparatus 900 receives the write data from the storage apparatus 100, and stores the received write data therein. In addition, data stored in the backup apparatus 900 is used as backup data in case that data stored in the storage apparatus 100 is unable to be used.

The storage apparatus 100 includes a data retaining unit 120, a storage unit 130, a storage unit 140, and a communication control unit 110. In addition, the storage unit 130 and the storage unit 140 may not be necessarily storage devices that are physically different from each other, but may be storage devices that are logically different from each other and are built on an identical storage device. Further, the storage apparatus 100 is sufficient, provided that it includes a plurality of storage units, and may include three or more storage units.

The storage unit 130 retains write data having been written into itself. The storage unit 130 is constituted of, for example, hard disk drives (HDDs) or solid state disks (SSDs).

The storage unit 140 retains write data having been written into itself. The storage unit 140 is constituted of, for example, hard disk drives (HDDs) or solid state disks (SSDs).

The data retaining unit 120 causes write data that has been received from the host 800 and is to be written into one of the storage units to be written into the one of the storage units. Further, the data retaining unit 120 temporarily retains write data that is written into one of the storage units; identification information indicating a storage unit that is a writing destination of the write data; clock time information indicating a clock time of the writing of the write data, until the write data is transmitted to the backup apparatus 900. In addition, the function of the data retaining unit 120 may be divided into a plurality of functional elements each associated with a corresponding one of the storage units. The individual functional elements resulting from the division of the function of the data retaining unit 120 may be communicably connected to one another, and thereby may function as a single data retaining unit 120.

The communication control unit 110 aggregates a “pre-transmission RPO” relating to each of the storage units. Further, the communication control unit 110 calculates, for each of the storage units, a weight (hereinafter, referred to as a “priority level”) having a positive correlation with the aggregated pre-transmission RPO, and assigns a transmission bandwidth for transmission of un-transmitted write data relating to each of the storage units on the basis of the calculated priority level. In addition, hereinafter, the above phrase: “assign a transmission bandwidth for transmission of un-transmitted write data relating to each of the storage units” will be abbreviated to just “assign a transmission bandwidth to each of the storage units”.

In addition, the “pre-transmission RPO” relating to each of the storage units is a time difference between an oldest data-writing clock time for each of the storage units and a predetermined “reference clock time” with respect to un-transmitted write data retained by the data retaining unit 120. That is, the pre-transmission RPO relating to each of the storage units is a time difference between an oldest data-writing clock time for each of the storage units and a predetermined “reference clock time” in the case where write data relating to the relevant storage unit and having been retained by the data retaining unit 120 remains in a state of being not transmitted to the backup apparatus 900. The “reference clock time” is, for example, a current clock time corresponding to a timing point at which the pre-transmission RPO relating to each of the storage units is aggregated. Alternatively, in the case where the transmission of write data is performed at intervals of a constant transmission cycle, the “reference clock time” may be a specific constant timing point during each of the intervals of the constant transmission cycle.

Further, the priority level is a certain amount having a positive correlation with the pre-transmission RPO. The priority level of each of the storage units is, for example, a pre-transmission RPO itself relating to each of the storage units; the power of the pre-transmission RPO; or a product resulting from multiplying the pre-transmission RPO by an amount of write data being retained by the data retaining unit 120 and relating to each of the storage units.

The communication control unit 110 transmits, for each of the storage units, write data to the backup apparatus 900 in order from the oldest one of the write data in accordance with the assigned transmission bandwidth.

The host 800 transmits mutually different kinds of write data to the respective storage units 130 and 140.

The backup apparatus 900 includes a communication unit 910, a storage unit 930, and a storage unit 940. The communication unit 910 receives write data from the storage apparatus 100. The backup apparatus 900 stores data written into the storage unit 130 into the storage unit 930 and stores data written into the storage unit 140 into the storage unit 940. In addition, the storage unit 930 and the storage unit 940 may not be necessarily storage devices that are physically different from each other, but may be storage devices that are logically different from each other and are built on an identical storage device. Further, the backup apparatus 900 is sufficient, provided that it includes a plurality of storage units whose total number is the same as the total number of the storage units included in the storage apparatus 100, and may include three or more storage units.

Next, the operation of this exemplary embodiment will be described.

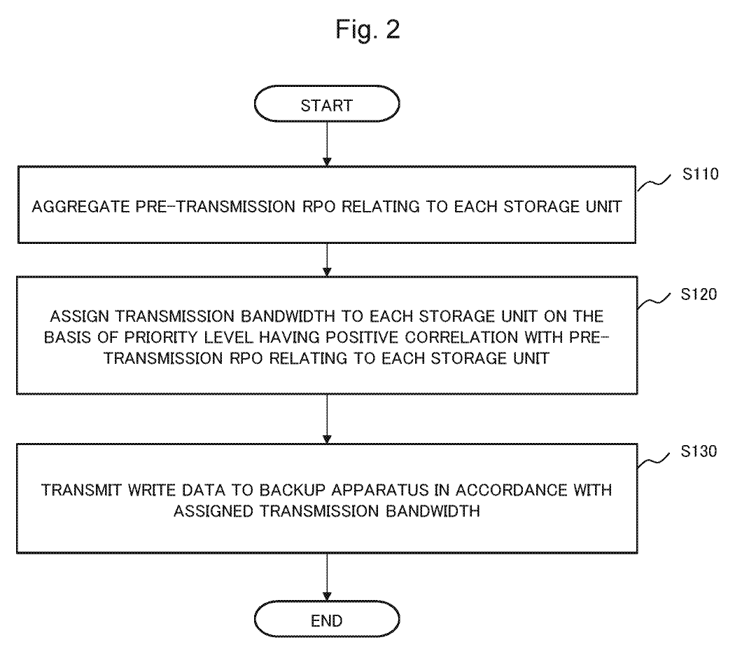

FIG. 2 is a flowchart illustrating the operation of the storage apparatus 100 according to this first exemplary embodiment of the present invention. Specifically, FIG. 2 illustrates processing performed by the communication control unit 110. In addition, the flowchart that is illustrated in FIG. 2 and will be described below is just an example, and the interchange of processing turns of some processes, the return of its process flow from a certain process to another process, and/or the iteration of a process or some successive processes may be performed optionally in accordance with required processing.

First, the communication control unit 110 aggregates a pre-transmission RPO relating to each of the storage units (step S110).

Next, the communication control unit 110 calculates, for each of the storage units, a priority level having a positive correlation with the aggregated pre-transmission RPO, and assigns a transmission bandwidth to each of the storage units on the basis of the calculated priority level (step S120). In addition, the communication control unit 110 does not always need to assign a transmission bandwidth to each of the storage units on the basis of the above priority level, and there are several variations. For example, in the case where all of write data retained by the data retaining unit 120 are unable to be transmitted within an upper limit bandwidth, the communication control unit 110 may assign a transmission bandwidth to each of the storage units on the basis of the above priority level. Alternatively, for example, in the case where any write data relating to each of one or more of the storage units and being included in the write data retained by the data retaining unit 120 is unable to be transmitted within an upper limit bandwidth, the communication control unit 110 may assign a transmission bandwidth to each of the storage units on the basis of the above priority. Further, the communication control unit 110 may not necessarily need to assign a transmission bandwidth to each of all of the storage units on the basis of the above priority level. For example, the communication control unit 110 may assign a transmission bandwidth to each of storage units except for one storage unit on the basis of the above priority level, and may assign a remaining transmission bandwidth to the one storage unit. Further, the communication control unit 110 may not assign all of a whole transmission bandwidth to each of the storage units on the basis of the above priority level. For example, the communication control unit 110 may secure a minimum bandwidth of the whole transmission bandwidth for the purpose of transmission of each of the storage units, and then may assign a remaining bandwidth to each of the storage units on the basis of the above priority level.

Next, the communication control unit 110 transmits, for each of the storage units, write data to the backup apparatus 900 in order from the oldest one of the write data in accordance with the assigned transmission bandwidth (step S130).

In addition, the communication control unit 110 repeatedly executes the whole of the above processing at predetermined timing points.

Next, specific examples of the processing performed in this exemplary embodiment will be described.

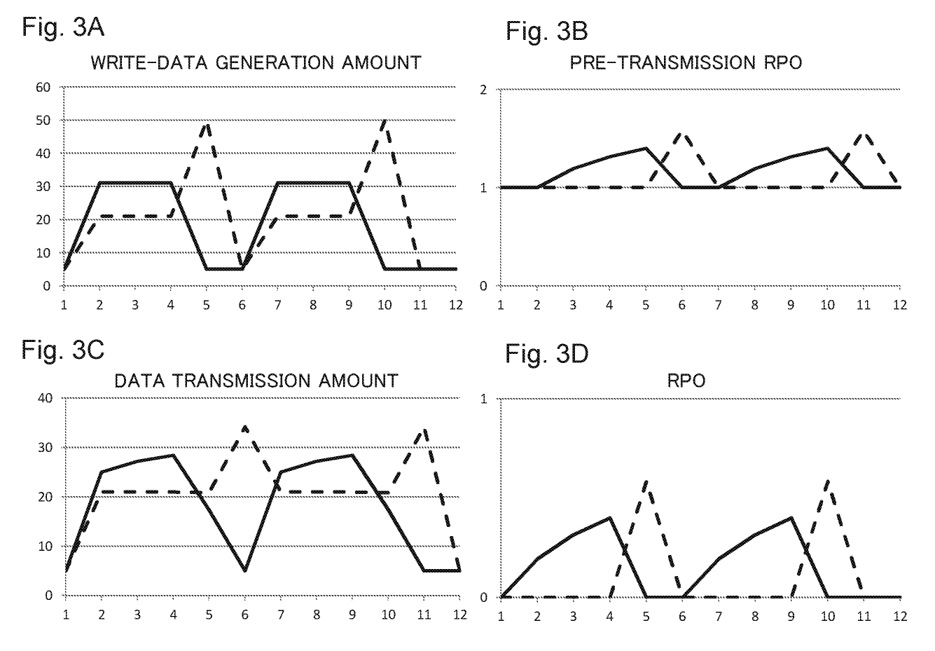

FIG. 3 is a diagram that describes specific examples of the processing performed by the storage apparatus 100 according to this first exemplary embodiment of the present invention. FIG. 3A illustrates a specific example of the temporal change of a data generation amount of data having been input to the storage apparatus 100 from the host 800. FIG. 3B illustrates a specific example of the temporal change of a pre-transmission RPO relating to data retained by the storage apparatus 100. FIG. 3C illustrates a specific example of the temporal change of a data transmission amount of data that is transmitted from the storage apparatus 100 to the backup apparatus 900. FIG. 3D illustrates a specific example of the temporal change of an RPO in the backup apparatus 900. The temporal change of the RPO in the backup apparatus 900 is represented by a larger one of the values of two graphs. Further, a graph regarding the storage unit 130 (a storage unit A) is denoted by a solid line, and a graph regarding the storage unit 140 (a storage unit B) is denoted by a dashed line. Further, with respect to a vertical axis and a horizontal axis in each of the graphs, unit is omitted from illustration. Further, the upper limit bandwidth of the sum of assigned transmission bandwidths is “50” per unit time. Further, the communication control unit 110 repeatedly executes the whole of the above processes in steps S110 to S130 at intervals of one unit time. Further, each of the graphs in FIG. 3 illustrates a simulation result. Hereinafter, a case where, when all of write data retained by the data retaining unit 120 are unable to be transmitted within an upper limit bandwidth, the communication control unit 110 assigns a transmission bandwidth to each of the storage units in accordance with a priority level that is an aggregated pre-transmission RPO itself relating to each of the storage units will be described.

FIG. 3A will be described below. The data generation speed of the storage unit A iterates increasing and decreasing within a range from “5” to “31”. The data generation speed of the storage unit B iterates increasing and decreasing within a range from “5” to “50”. The sum of the data generation speeds of the storage units A and B is smaller than or equal to the upper limit bandwidth “50” at clock times “1”, “6”, “11”, and “12”, but exceeds the upper limit bandwidth “50” at each of clock times other than the above clock times.

First, the communication control unit 110 aggregates a pre-transmission RPO relating to each the storage units and being shown in FIG. 3B (step S110).

Next, the communication control unit 110 handles, for each of the storage units, the aggregated pre-transmission RPO as a priority level, and assigns a transmission bandwidth proportional to the priority level to each of the storage units (step S120). In addition, in the case where all of the write data retained by the data retaining unit 120 are able to be transmitted within the upper limit bandwidth, the communication control unit 110 assigns a transmission bandwidth to each of the storage units such that the all of the write data retained by the data retaining unit 120 are transmitted. In addition, it is determined by comparing the amount of all of the write data retained by the data retaining unit 120 with the width of the upper limit bandwidth whether all of the write data retained by the data retaining unit 120 are able to be transmitted within the upper limit bandwidth.

Next, as shown in FIG. 3C, first, the communication control unit 110 transmits, for each of the storage units, write data retained by the data retaining unit 120 to the backup apparatus 900 in order from the oldest one of the write data in accordance with the assigned transmission bandwidth (step S130).

As a result of the above operation, as shown in FIG. 3D, an RPO relating to each of the storage units A and B with respect to write data received by the backup apparatus 900 is suppressed to a value smaller than or equal to approximately “0.6”.

Next, a specific example of processing performed by a storage apparatus (not illustrated) that is a comparison example will be described. In addition, this comparison example is not a storage apparatus according to this exemplary embodiment.

The storage apparatus as a comparison example transmits, with high priority, write data relating to one of storage units and including write data having a pre-transmission RPO that is larger than that of write data relating to any other one of the storage units, and transmits write data relating to the other one of the storage units if there exists a remaining transmission bandwidth. That is, the storage apparatus as a comparison example does not perform transmission of write data relating to one of the storage units and including write data having a pre-transmission RPO that is larger than that of write data relating to any other one of the storage units, simultaneously with transmission of write data relating to the other one of the storage units. In addition, in case that there exists a plurality of storage units for each of which write data having a pre-transmission RPO that is larger than that of write data relating to any other storage unit exists, any one of the plurality of storage units (a storage unit A in this operation example) is deemed and selected as a storage unit including write data having a pre-transmission RPO that is larger than that of write data relating to any other storage unit.

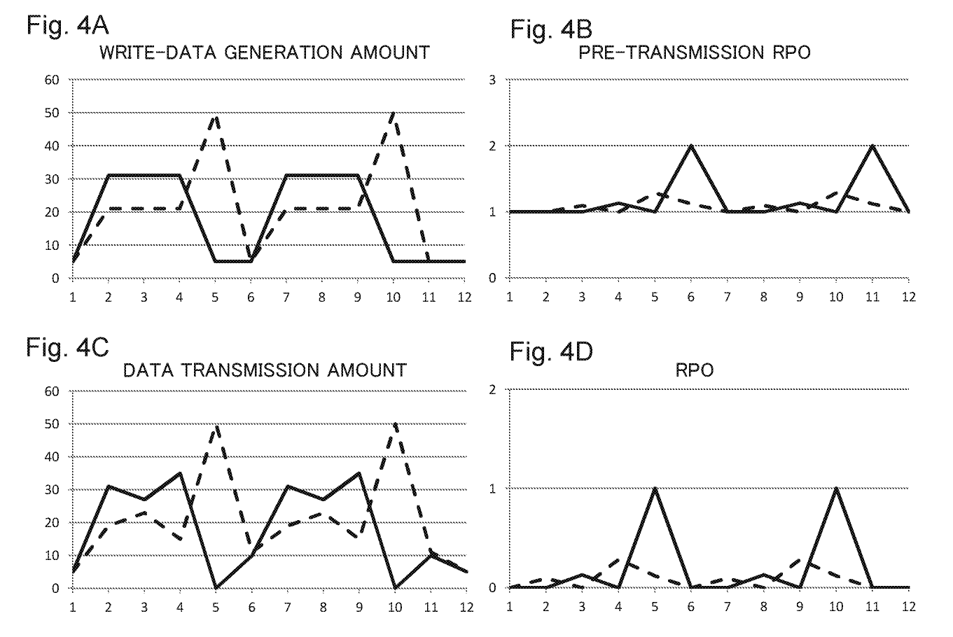

FIG. 4 is a diagram that describes specific examples of processing performed by the storage apparatus as a comparison example. Preconditions for FIG. 4 are the same as those for FIG. 3 except that the storage apparatus 100 is replaced by the storage apparatus as a comparison example.

As shown in FIG. 4C, at clock times “5” and “10”, the storage apparatus as a comparison example transmits write data relating to a storage unit B among write data retained by the data retaining unit 120, but does not transmit any write data relating to a storage unit A among the write data retained thereby.

As shown in FIG. 4D, an RPO relating to the storage unit A with respect to write data received by a backup apparatus reaches approximately “1.0”. In contrast, in the case of the storage apparatus 100, an RPO relating to each of the storages A and B is suppressed to a value smaller than or equal to approximately “0.6”. Accordingly, in the case of the storage apparatus 100, the increase of the RPO is suppressed to a greater degree, as compared with the case of the storage apparatus of a comparison example.

As described above, the storage apparatus 100 according to this exemplary embodiment assigns a transmission bandwidth to each of the storage units on the basis of a priority level having a positive correlation with a pre-transmission RPO relating to each of the storage units. That is, the storage apparatus 100 concurrently suppresses the increase of the RPO relating to each of the storage units. Accordingly, the storage apparatus 100 according to this exemplary embodiment has an advantageous effect in that even if the speed of generation of write data to be written into a storage device of the storage apparatus 100 temporarily exceeds the bandwidth of a communication line communicably connected to the backup apparatus 900, the increase of a recovery point objective can be suppressed.

In addition, in the above specific example, it has been described a case where, when all of write data retained by the data retaining unit 120 are unable to be transmitted within an upper limit bandwidth, the communication control unit 110 assigns a transmission bandwidth to each of the storage units in accordance with a priority level having been calculated and given to each of the storage units on the basis of an aggregated pre-transmission RPO relating to each of the storage units. Even if, however, any one of the variations relating to the method for assigning transmission bandwidths and having been indicated in the description regarding step S120 is employed, the storage apparatus 100 according to this exemplary embodiment performs operation similar to that in the above specific example. Accordingly, even if any one of the variations relating to the method for assigning transmission bandwidths and having been indicated in the description regarding step S120 is employed, an advantageous effect of substantially the same degree as the degree of the aforementioned advantageous effect is brought about.

### Second Exemplary Embodiment

Next, a second exemplary embodiment according to the present invention and being based on the aforementioned first exemplary embodiment according to the present invention will be described in detail with reference to some of the drawings. In this exemplary embodiment, a transmission bandwidth is assigned to each of at least one storage unit except for one specific storage unit on the basis of a pre-transmission RPO relating to each of at least one storage unit, and a remaining transmission bandwidth is assigned to the one specific storage unit. In following description, constituent elements similar to the constituent elements of the first exemplary embodiment are denoted by the same reference signs as those of the constituent elements of the first exemplary embodiment, and description thereof will be appropriately omitted.

The configuration of this exemplary embodiment will be described below.

The configuration of a storage apparatus 200 according to this exemplary embodiment is same as that of the storage apparatus 100 according to the first exemplary embodiment. In this regard, however, the operation of a communication control unit 210 of the storage apparatus 200 according to this exemplary embodiment is different from that of the communication control unit 110 of the storage apparatus 100 according to the first exemplary embodiment.

Next, the operation in this exemplary embodiment will be described.

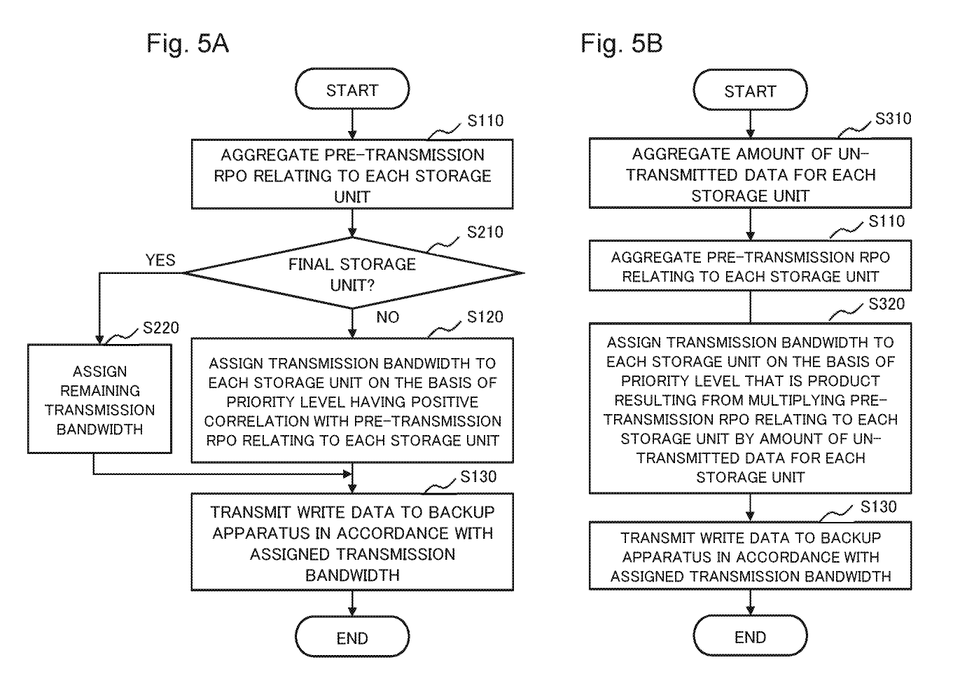

FIG. 5A is a flowchart illustrating the operation of the storage apparatus 200 according to this second exemplary embodiment of the present invention. Specifically, FIG. 5A illustrates processing performed by the communication control unit 210. In addition, the flowchart that is illustrated in FIG. 5A and will be described below is just an example, and the interchange of processing turns of some processes, the return of its process flow from a certain process to another process, and/or the iteration of a process or some successive processes may be performed optionally in accordance with required processing.

First, the communication control unit 210 aggregates a pre-transmission RPO relating to each of storage units (step S110).

Next, before sequentially assigning a transmission bandwidth to each of the storage units, the communication control unit 210 determines in advance whether an assignment target storage unit is a final one of the storage units that are to be subjected to the assignment of a transmission bandwidth (step S210).

In the case where the assignment target storage unit is not the final one of the storage units (No in step S210), the communication control unit 210 calculates a priority level having a positive correlation with an aggregated pre-transmission RPO relating to the assignment target storage unit, and assigns a transmission bandwidth to the assignment target storage unit on the basis of the calculated priority level (step S120).

In the case where the assignment target storage unit is the final one of the storage units (Yes in step S210), the communication control unit 210 assigns the whole of a remaining transmission bandwidth to the assignment target storage unit (step S220).

Next, the communication control unit 210 transmits, for each of the storage units, write data to the backup apparatus 900 in order from the oldest one of the write data in accordance with the assigned transmission bandwidth (step S130).

In addition, the communication control unit 210 repeatedly executes the whole of the above processing at predetermined timing points.

Further, operation other than the above operation in this exemplary embodiment is the same as corresponding operation in the first exemplary embodiment.

As described above, the storage apparatus 200 according to this exemplary embodiment assigns a transmission bandwidth to each of at least one storage unit except for one specific storage unit on the basis of a pre-transmission RPO relating to each of the at least one storage unit. Accordingly, the storage apparatus 200 according to this exemplary embodiment brings about the same advantageous effect as that of the first exemplary embodiment.

Further, the storage apparatus 200 according to this exemplary embodiment assigns a remaining transmission bandwidth to the one specific storage unit. Accordingly, the storage apparatus 200 according to this exemplary embodiment brings about an advantageous effect in that there is no unassigned transmission bandwidth.

### Third Exemplary Embodiment

Next, a third exemplary embodiment according to the present invention and being based on the aforementioned first exemplary embodiment according to the present invention will be described in detail with reference to some of the drawings. In this exemplary embodiment, a transmission bandwidth is assigned to each of storage units on the basis of both a pre-transmission RPO and an amount of un-transmitted write data with respect to each of the storage units. In following description, constituent elements similar to the constituent elements of the first exemplary embodiment are denoted by the same reference signs as those of the constituent elements of the first exemplary embodiment, and description thereof will be appropriately omitted.

The configuration of this exemplary embodiment will be described below.

The configuration of a storage apparatus 300 according to this exemplary embodiment is the same as that of the storage apparatus 100 according to the first exemplary embodiment. In this respect, however, the operation of a communication control unit 310 of the storage apparatus 300 according to this exemplary embodiment is different from that of the communication control unit 110 of the storage apparatus 100 according to the first exemplary embodiment.

Next, the operation in this exemplary embodiment will be described.

FIG. 5B is a flowchart illustrating the operation of the storage apparatus 300 according to this third exemplary embodiment of the present invention. Specifically, FIG. 5B illustrates processing performed by the communication control unit 310. In addition, the flowchart that is illustrated in FIG. 5B and will be described below is just an example, and the interchange of processing turns of some processes, the return of its process flow from a certain process to another process, and/or the iteration of a process or some successive processes may be performed optionally in accordance with required processing.

First, the communication control unit 310 aggregates an amount of un-transmitted write data for each of storage units (step S310).

Next, the communication control unit 310 aggregates a pre-transmission RPO relating to each of the storage units (step S110).

Next, the communication control unit 310 calculates, for each of the storage units, a priority level that is a product resulting from multiplying the aggregated pre-transmission RPO by the aggregated amount of un-transmitted write data, and assigns a transmission bandwidth to each of the storage units on the basis of the calculated priority level (step S320).

Next, the communication control unit 310 transmits, for each of the storage units, write data to the backup apparatus 900 in order from the oldest one of the write data in accordance with the assigned transmission bandwidth (step S130).

In addition, the communication control unit 310 repeatedly executes the whole of the above processing at predetermined timing points.

Further, operation other than the above operation in this exemplary embodiment is the same as corresponding operation in the first exemplary embodiment.

As described above, the storage apparatus 300 according to this exemplary embodiment assigns a transmission bandwidth having a positive correlation with a pre-transmission RPO relating to each of the storage units to each of the storage units. Accordingly, the storage apparatus 300 according to this exemplary embodiment brings about the same advantageous effect as that of the first exemplary embodiment.

Further, the storage apparatus 300 according to this exemplary embodiment assigns a transmission bandwidth having a positive correlation with an amount of un-transmitted write data relating to each of the storage units to each of the storage units. Accordingly, the storage apparatus 300 according to this exemplary embodiment brings about an advantageous effect in that, even if there is no difference between pre-transmission RPOs relating to the respective storage units, a transmission bandwidth is assigned to each of the storage units in accordance with an amount of un-transmitted write data relating to each of the storage units.

### Fourth Exemplary Embodiment

Next, a fourth exemplary embodiment according to the present invention and being based on the aforementioned first exemplary embodiment according to the present invention will be described in detail with reference to some of the drawings. In this exemplary embodiment, a storage apparatus receives write data from each of host apparatuses via mutually different signal lines each communicably connected from the relevant host apparatus to a corresponding one of storage units included in the storage apparatus. Further, in this exemplary embodiment, the storage apparatus transmits write data to a backup apparatus via mutually different communication interfaces each associated with a corresponding one of the storage units included in the storage apparatus. In following description, constituent elements similar to the constituent elements of the first exemplary embodiment are denoted by the same reference signs as those of the constituent elements of the first exemplary embodiment, and description thereof will be appropriately omitted.

The configuration of this exemplary embodiment will be described below.

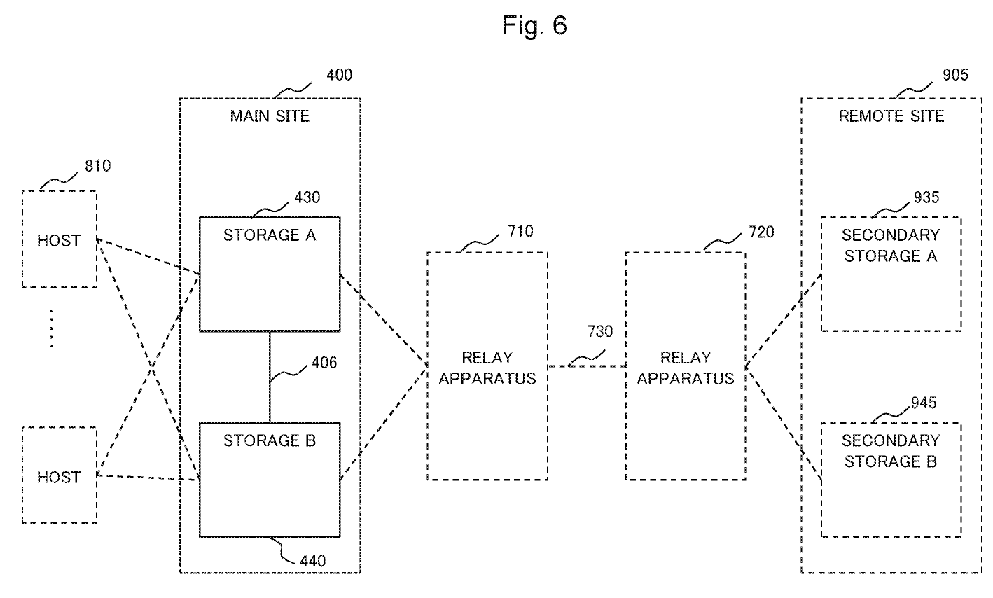

FIG. 6 is a block diagram illustrating an example of the configuration of a storage apparatus according to this fourth exemplary embodiment of the present invention. A main site 400 that is a storage apparatus according to this exemplary embodiment includes a storage 430 (a storage A) and a storage 440 (a storage B) that are storage units. The storage A is communicably connected to each of hosts 810, and the storage B is communicably connected to each of the hosts 810. The main site 400 corresponds to the storage apparatus 100 according to the first exemplary embodiment. A remote site 905 that is a backup apparatus includes a secondary storage 935 (a secondary storage A) and a secondary storage 945 (a secondary storage B) that are storage units. The storage A and the storage B are communicably connected to each other via a communication line 406. The storage A and the storage B share a relay apparatus 710, a relay apparatus 720, and a network 730. The storage A transmits data to the secondary storage A, and the storage B transmits data to the secondary storage B.

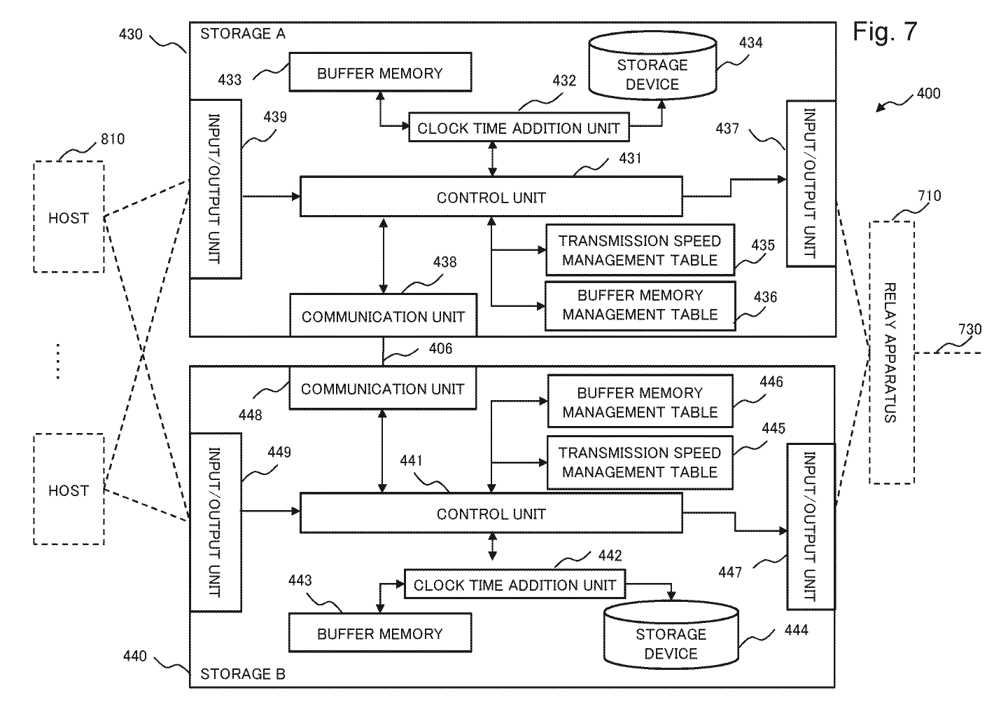

FIG. 7 is a block diagram illustrating an example of the detailed configuration of the main site 400 according to this fourth exemplary embodiment of the present invention. Specifically, FIG. 7 illustrates the detailed configuration of each of the storages A and B of the main site 400.

The storage A will be described below.

The storage A includes an input/output unit 439, a clock time addition unit 432, a control unit 431, a buffer memory 433, a storage device 434, a buffer memory management table 436, an input/output unit 437, a communication unit 438, and a transmission speed management table 435. Further, the storage B includes an input/output unit 449, a clock time addition unit 442, a control unit 441, a buffer memory 443, a storage device 444, a buffer memory management table 446, an input/output unit 447, a communication unit 448, and a transmission speed management table 445. The storage B has the same configuration as that of the storage A.

The input/output unit 439 receives write data from each of the hosts 810.

The clock time addition unit 432 writes write data having been received by the input/output unit 439 into both of the buffer memory 433 and the storage device 434. Simultaneously with this writing operation, the clock time addition unit 432 writes an address of the write data, a current clock time, and a “transmission state” of the write data into the buffer memory management table 436 via the control unit 431. The “transmission state” is information indicating in which of a state of being transmitted and a state of waiting for transmission the write data is.

The buffer memory 433 retains data having been written into the storage device 434 until the data is transmitted to the secondary storage A of the remote site 905.

The storage device 434 retains data having been written thereinto.

The buffer memory management table 436 retains an address, a clock time of writing into the storage device 434, and a transmission state, with respect to each of at least one un-transmitted block of write data.

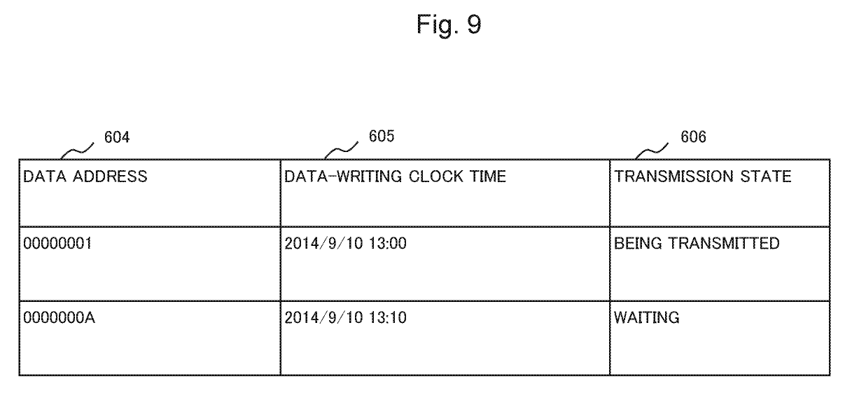

FIG. 9 is a diagram illustrating an example of the buffer memory management table 436 of the main site 400 according to this exemplary embodiment. In FIG. 9, a column “data address” indicates the address of each of at least one block of write data; a column “data-writing clock time” indicates the clock time of writing of each of the at least one block of write data; and a column “transmission state” indicates the transmission state of each of the at least one block of write data. A first column in FIG. 9 shows that the address is “00000001”; the data-writing clock time is “2014/9/10 13:00” and the transmission state is “being transmitted”. A second column in FIG. 9 shows that the address is “0000000A”; the data-writing clock time is “2014/9/10 13:10” and the transmission state is “waiting”.

Let us return to the description of FIG. 7.

The input/output unit 437 transmits write data retained by the buffer memory 433 to the relay apparatus 710.

The communication unit 438 is communicably connected to the communication unit 448 of the storage B. The communication unit 438 is a communication unit for sharing an oldest data-writing clock time among data-writing clock times 605 retained by the buffer memory management table 436 with the storage B.

The transmission speed management table 435 retains an identifier of each of the storage units; an oldest data-writing clock time relating to each of the storage units; and a data transmission speed of each of the storage units.

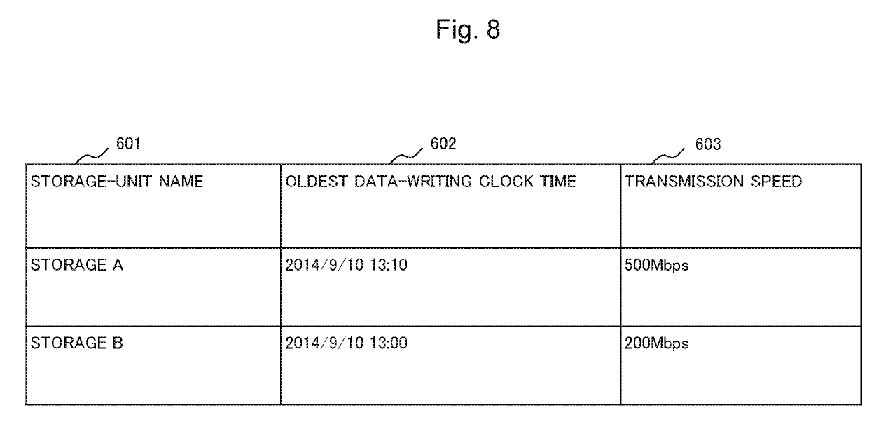

FIG. 8 is a diagram illustrating an example of the transmission speed management table 435 of the main site 400 according to this exemplary embodiment. In FIG. 8, a column “storage-unit name” indicates the identifier of each of the storage units; a column “oldest data-writing clock time” indicates the oldest data-writing clock time relating to un-transmitted writing data for each of the storage units; and a column “transmission speed” indicates the transmission speed of data relating to each of the storage units. A first column in FIG. 8 shows that the identifier of a storage unit is “storage A”; the oldest data-writing clock time is “2014/9/10 13:10”; and the transmission speed is “500 Mbps”. A second column in FIG. 8 shows that the identifier of a storage unit is “storage B”; the oldest data-writing clock time is “2014/9/10 13:00”; and the transmission speed is “200 Mbps”.

Let us return to the description of FIG. 7.

The control unit 431 determines a transmission speed for each of the storage units contained in the transmission speed management table 435 on the basis of an oldest data-writing clock times relating to the respective storage units. Further, the control unit 431 controls the transmission speed of the input/output unit 437 on the basis of the determined transmission speed for each of the storage units contained in the transmission speed management table 435.

The storage B has the same detailed configuration as that of the storage A.

Next, the operation of the main site 400 according to this exemplary embodiment will be described. In addition, the description will be made by providing an example of the operation of the storage A unless particularly noted.

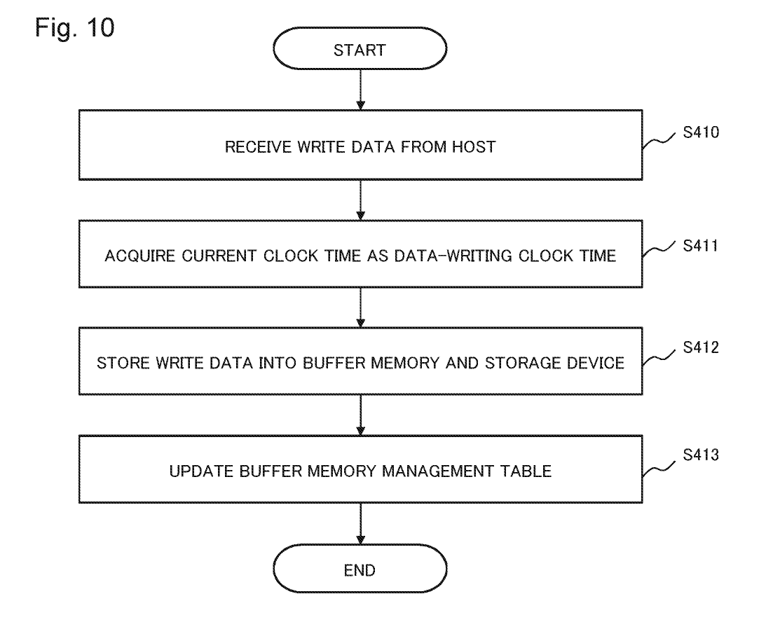

FIG. 10 is a flowchart illustrating the operation of the main site 400 in case that the main site 400 has received write data from one of the hosts 810, according to this fourth exemplary embodiment of the present invention. Specifically, FIG. 10 illustrates the operation of a storage unit (i.e., the storage A or the storage B) in case that the relevant storage unit has received write data from one of the hosts 810. The operation of the storage A will be described below. In addition, the flowchart that is illustrated in FIG. 10 and will be described below is just an example, and the interchange of processing turns of some processes, the return of its process flow from a certain process to another process, and/or the iteration of a process or some successive processes may be performed optionally in accordance with required processing.

The input/output unit 439 receives write data from one of the hosts 810 (step S410).

The clock time addition unit 432 acquires a current clock time as the writing clock time of the received write data (step S411).

The clock time addition unit 432 writes the received write data into both of the buffer memory 433 and the storage device 434 (step S412).

In the buffer memory management table 436, the clock time addition unit 432 registers an address of the write data in the buffer memory 433 into a field for a data address 604; registers a data-writing clock time relating to the write data into a field for the data-writing clock time 605; and registers a transmission state of the write data, which is “waiting” in this case, into a field for a transmission state 606 (step S413).

The above operation is repeatedly executed.

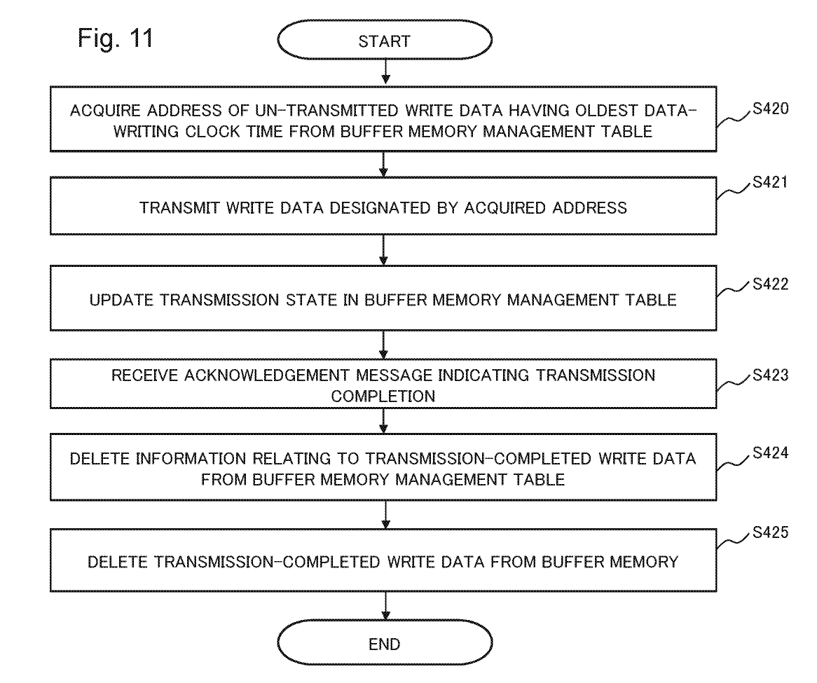

FIG. 11 is a flowchart illustrating the operation of data transmission to the remote site 905 by the main site 400, according to this fourth exemplary embodiment of the present invention. Specifically, FIG. 11 illustrates operation in which a storage unit transmits write data to a storage unit of the remote site 905. The operation of the storage A will be described below. In addition, the flowchart that is illustrated in FIG. 11 and will be described below is just an example, and the interchange of processing turns of some processes, the return of its process flow from a certain process to another process, and/or the iteration of a process or some successive processes may be performed optionally in accordance with required processing.

The input/output unit 437 searches the buffer memory management table 436 for a row of data including a transmission state 606 that is “waiting” and a data-writing clock time 605 that is older than that included in any other row of data, and acquires a data address 604 included in the row of data having been searched for (step S420).

The input/output unit 437 transmits write data that is retained by the buffer memory 433 and that is designated by the acquired data address 604 to the secondary storage A (step S421).

The input/output unit 437 updates the transmission state 606 included in the row of data having been searched for and being contained in the buffer memory management table 436 into “being transmitted” (step S422).

After having completed the transmission of the write data to the secondary storage A, the input/output unit 437 receives an acknowledgement message (step S423).

The input/output unit 437 deletes information relating to the transmitted write data from the buffer memory management table 436 (step S424).

The input/output unit 437 deletes the transmitted write data from the buffer memory 433 (step S425).

In addition, the operation shown in FIG. 11 is executed in parallel with the operation shown in FIG. 10. Further, the transmission speed is controlled by the control unit 431 on the basis of the value of a transmission speed 603 contained in the transmission speed management table 435 (this detailed description will be made below).

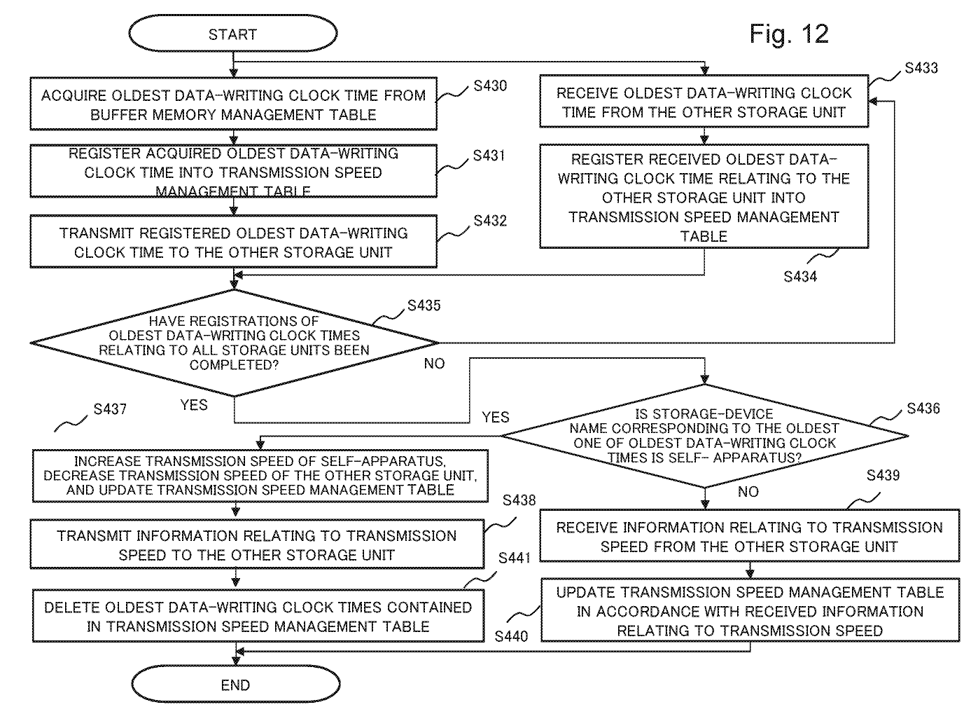

FIG. 12 is a flowchart illustrating the operation of data transmission speed control by the main site 400, according to this fourth exemplary embodiment of the present invention. Specifically, FIG. 12 illustrates a procedure in which the storage units (the storages A and B) of the main site 400 share oldest writing clock times relating to the respective storage units, and thereby the storage units control their respective transmission speeds. The operation of the storage A will be described below. In addition, the flowchart that is illustrated in FIG. 12 and will be described below is just an example, and the interchange of processing turns of some processes, the return of its process flow from a certain process to another process, and/or the iteration of a process or some successive processes may be performed optionally in accordance with required processing.

The control unit 431 searches the data-writing clock times 605 of the buffer memory management table 436 for an oldest data-writing clock time among the data-writing clock times 605, and acquires the relevant oldest data-writing clock time (step S430).

The control unit 431 searches the storage-unit names 601 of the transmission speed management table 435 for a self storage-unit name (“storage A”), and registers the acquired oldest data-writing clock time, as a new oldest data-writing clock time 602, into a field relating to the oldest data-writing clock time 602 and corresponding to the self storage-unit name (“storage A”) having been searched for (step S431).

The control unit 431 transmits the value of the registered new oldest data-writing clock time to the storage B by using the communication unit 438 (step S432).

Further, the control unit 431 receives the value of a new oldest data-writing clock time that is transmitted by the storage B having performed the same processing as that having been performed by the storage A (step S433).

The control unit 431 searches the storage-unit names of the transmission speed management table 435 for a storage-unit name (“storage B”) corresponding to the received new oldest data-writing clock time, and registers the received new oldest data-writing clock time into a field relating to the oldest data-writing clock time 602 and corresponding to the storage-unit name (“storage B”) having been searched for (step S434).

In addition, the processes in steps S433 and S434 are executed in parallel with the processes in steps S430, S431, and S432. Further, in the case where a plurality of other storage units exist, the control unit 431 waits for receptions from the plurality of other storage units and executes the processes in steps S433 and S434 upon reception from each of the plurality of other storage units until the completion of the registrations of oldest data-writing clock times relating to all of the storage units into fields each relating to the oldest data-writing clock time 602 and being contained in the transmission speed management table 435 (No in step S435).

If the registrations of the oldest data-writing clock times relating to all of the storage units have been completed (Yes in step S435), the control unit 431 searches the oldest data-writing clock times 602 each associated with a corresponding one of all of the storage units for the oldest one of the oldest data-writing clock times 602. In the case where a storage-unit name corresponding to the oldest one of the oldest data-writing clock times 602 is a self-apparatus (“storage A”) (Yes in step S436), the control unit 431 decreases the transmission speed 603 of the other storage unit by a predetermined amount (for example, “150 Mbps”); increases the transmission speed 603 of the self-apparatus (“storage A”) by a predetermined amount (for example, “150 Mbps”); and then updates the transmission speed management table 435 to reflect the above changes (step S437). In addition, when a transmission speed is decreased, a resultant decreased transmission speed is set so as to be kept to a value larger than zero.

The control unit 431 transmits information contained in the transmission speed management table 435 to the other storage unit (“storage B”) (step S438).

In contrast, in the case where a storage-unit name corresponding to the searched-for further oldest data-writing clock time is not the self-apparatus (No in step S436), the control unit 431 receives information contained in the transmission speed management table 445 from the other storage unit (“storage B”) (step S439).

The control unit 431 updates information contained in the transmission speed management table 435 in accordance with the received information contained in the transmission speed management table 445 (step S440) and terminates the operation.

After the completion of the process in step S438, the control unit 431 deletes the values of the oldest data-writing clock times 602, and initializes the values of the transmission speeds 603 (step S441). For example, the initial value of each of the values of the transmission speeds 603 is a value (for example, “350 Mbps”) resulting from dividing a whole transmission bandwidth (for example, “700 Mbps”) of the network 730 by the number of the storage units (for example, “2”).

In addition, the operation shown in FIG. 12 is carried out at intervals of, for example, a predetermined constant cycle that is set by an administrator. Further, the operation shown in FIG. 12 is carried out in parallel with the operation shown in FIG. 10 and the operation shown in FIG. 11. Further, storage-unit names that are registered in the fields for the storage-unit names 601 in the transmission speed management table 435 as well as the initial values of transmission speeds that are registered in the fields for the transmission speed fields 603 in the transmission speed management table 435 are set by an administrator in advance.

As described above, the main site 400 according to this exemplary embodiment is configured to, in case of causing each of storage units to transmit write data to the remote site 905, perform control such that the transmission speed of one of the storage units, which retains write data whose oldest data-writing clock time is older than that of write data retained by the other one of the storage units, is made higher than a current transmission speed of the one of the storage units, and the transmission speed of the other one of the storage units, which retains write data whose oldest data-writing clock time is newer than that of the write data retained by the one of the storage units, is made lower than a current transmission speed of the other one of the storage units. Further, when a transmission speed is decreased, a resultant decreased transmission speed is set so as to be kept to a value larger than zero. That is, with respect to not only write data that is transmitted from a storage unit whose transmission speed has been increased, but also write data that is transmitted from a storage unit whose transmission speed has been decreased, the increase of the RPO is suppressed. Accordingly, the main site 400 according to this exemplary embodiment has an advantageous effect in that even if the speed of generation of write data in the storage apparatus (the main site 400) temporarily exceeds the bandwidth of a communication line connected to the backup apparatus (the remote site 905), the increase of the recovery point objective can be suppressed.

In addition, even if three or more storage units exist in the main site 400, each of the storage units operates in the same way as that of the storage A described above. Further, the operation shown in each of FIGS. 10, 11, and 12 is just an example, and operation may not be necessarily performed in accordance with the operation shown in each of FIGS. 10, 11, and 12 except that the individual storage units share information relating to an oldest writing clock time with respect to un-transmitted write data retained by each of the storage units.

In addition, although the storage apparatus according to each of the aforementioned exemplary embodiments of the present invention may be realized by using a dedicated apparatus, the storage apparatus can be also realized by using a computer (an information processing apparatus). In this case, such a computer loads a software program stored in a memory device (not illustrated) into a central processing unit (CPU) (not illustrated) to cause the CPU to execute the loaded software program, and thereby the computer outputs the result of the execution to, for example, a user interface. In the case of each of the aforementioned exemplary embodiments, such a software program is sufficient, provided that the software program is written such that the aforementioned functions of the individual units of any one of the storage apparatus 100 shown in FIG. 1, the storage apparatus 200, the storage apparatus 300, and the main site 40 shown in FIG. 7 can be realized. In this regard, however, it is supposed that hardware is optionally included in the storage unit 130 of any one of the storage apparatus 100, the storage apparatus 200, and the storage apparatus 300; the storage device 434; the input/output unit 439; the input/output unit 437; the communication unit 438; the storage device 444; the input/output unit 449; the input/output unit 447; and/or the communication unit 448, which are included in the main site 400. Further, in such a case, it is possible to deem that such a software program (computer program) constitutes one of aspects of the present invention. Moreover, it is also possible to deem that a storage medium that is readable from a computer and that stores such a software program therein constitutes one of aspects of the present invention.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

This application is based upon and claims the benefit of priority from Japanese Patent Application No. 2015-055891, filed on Mar. 19, 2015, the disclosure of which is incorporated herein in its entirety by reference.

### INDUSTRIAL APPLICABILITY

The present invention can be utilized for use in improving an RPO in a remote backup of a storage apparatus.

### REFERENCE SIGNS LIST

100: Storage apparatus
120: Data retaining unit
130 and 140: Storage unit
110: Communication control unit
800: Host
900: Backup apparatus
910: Communication unit
930 and 940: Storage unit
400: Main site
406: Communication line
430 and 440: Storage
905: Remote site
935 and 945: Secondary storage
130 and 140: Storage unit
710 and 720: Relay apparatus
730: Network
810: Host
433 and 443: Buffer memory
439 and 449: Input/output unit
438 and 448: Communication unit
431 and 441: Control unit
432 and 442: Clock time addition unit
434 and 444: Storage device
437 and 447: Input/output unit
435 and 445: Transmission speed management table
436 and 446: Buffer memory management table
601: Storage-unit name
602: Data-writing time
603: Transmission speed
604: Data address
605: Data-writing time
606: Transmission state

What is claimed is:

1. A storage apparatus comprising:
a plurality of storage units;
a data retaining unit that temporarily retains a block of write data that is written into one of the plurality of storage units, a piece of information relating to a writing destination of the block of write data, and a piece of information relating to a writing clock time of the block of write data, until the retained block of write data is transmitted to an external backup apparatus; and
a communication control unit that aggregates an oldest writing clock time for each of the plurality of storage units from a plurality of the retained pieces of information each relating to the writing clock time, calculates, for each of the plurality of storage units, a priority level having a positive correlation with a time difference between the aggregated oldest writing clock time and a predetermined reference clock time, assigns, to each of the plurality of storage units, a transmission bandwidth for transmission of at least one retained block of write data for each of the plurality of storage units among a plurality of the retained blocks of write data based on the calculated priority level, and transmits, for each of the plurality of storage units, the at least one retained block of write data to the external backup apparatus in accordance with the assigned transmission bandwidth.

2. The storage apparatus according to claim 1,
wherein the transmission bandwidth assigned to each of one or more of the plurality of storage units except for one of the plurality of storage units is proportional to the priority level of each of one or more of the plurality of storage units, and the transmission bandwidth assigned to the one of the plurality of storage units is a remaining transmission bandwidth after the assignment of the transmission bandwidth to each of one or more of the plurality of storage units has been performed.

3. The storage apparatus according to claim 1,
wherein the priority level of each of the plurality of storage units is any one of the time difference, a power of the time difference, and a product resulting from multiplying an amount of at least one block of un-transmitted write data for each of the plurality of storage units by the time difference.

4. The storage apparatus according to claim 2,
wherein, in a case where all of the plurality of blocks of write data retained by the data retaining unit are unable to be transmitted within an upper limit of a whole transmission bandwidth, the communication control unit performs the assignment of the transmission bandwidth to each of the plurality of storage units based on the priority level.

5. The storage apparatus according to claim 2,
wherein, in a case where one or more blocks of write data relating to each of the plurality of storage units and constituting the plurality of blocks of write date retained by the data retaining unit are unable to be transmitted within an upper limit of a whole transmission bandwidth, the communication control unit performs the assignment of the transmission bandwidth to each of the plurality of storage units based on the priority level.

6. The storage apparatus according to claim 2,
wherein the communication control unit assigns, in addition to a predetermined communication bandwidth that constitutes a whole communication bandwidth and that is secured for communication of each of the plurality of storage units, a bandwidth other than the predetermined communication bandwidth within the whole communication bandwidth to each of the plurality of storage units as the transmission band width.

7. The storage apparatus according to claim 1, further comprising:
a first input unit through which a block of write data exclusive to a first one of the plurality of storage units is input,
a first communication unit that transmits the block of write data exclusive to the first one of the plurality of storage units,
a second input unit from which a block of write data exclusive to a second one of the plurality of storage units is input, and
a second communication unit that transmits the block of write data exclusive to the second one of the plurality of storage units,
wherein the data retaining unit includes a first data retaining unit that retains the block of write data having been input through the first input unit, and a second data retaining unit that retains the block of write data having been input through the second input unit,
wherein the communication control unit receives a first clock time that is an oldest writing clock time relating to the first one of the plurality of storage units, from the first data retaining unit, and receives a second clock time that is an oldest writing clock time relating to the second one of the plurality of storage units, from the second data retaining unit, and
wherein the communication control unit assigns a larger amount of transmission bandwidth to the first one of the plurality of storage units or the second one of the plurality of storage units, whichever corresponds to an older one of the two received clock times, and instructs each of the first communication unit and the second communication unit to perform setting of the assigned transmission bandwidth.

8. The storage controlling method comprising:
temporarily retaining a block of write data that is written into one of a plurality of storage units, a piece of information relating to a writing destination of the block of write data, and a piece of information relating to a writing clock time of the block of write data, until the retained block of write data is transmitted to an external backup apparatus;
aggregating an oldest writing clock time for each of the plurality of storage units from a plurality of the retained pieces of information each relating to the writing clock time;
calculating, for each of the plurality of storage units, a priority level having a positive correlation with a time difference between the aggregated oldest writing clock time and a predetermined reference clock time;
assigning, to each of the plurality of storage units, a transmission bandwidth for transmission of at least one retained block of write data for each of the plurality of storage units among a plurality of the retained blocks of write data based on the calculated priority level; and
transmitting, for each of the plurality of storage units, the at least one retained block of write data to the external backup apparatus in accordance with the assigned transmission bandwidth.

9. A computer-readable recording medium for recording a storage control program that causes a computer to execute processing comprising:
a data retaining process of temporarily retaining a block of write data that is written into one of a plurality of storage units, a piece of information relating to a writing destination of the block of write data, and a piece of information relating to a writing clock time of the block of write data, until the retained block of write data is transmitted to an external backup apparatus; and
a communication control process of aggregating an oldest writing clock time for each of the plurality of storage units from a plurality of the retained pieces of information each relating to the writing clock time, calculating, for each of the plurality of storage units, a priority level having a positive correlation with a time difference between the aggregated oldest writing clock time and a predetermined reference clock time, assigning, to each of the plurality of storage units, a transmission bandwidth for transmission of at least one retained block of write data for each of the plurality of storage units among a plurality of the retained blocks of write data based on the calculated priority level, and transmitting, for each of the plurality of storage units, the at least one retained block of write data to the external backup apparatus in accordance with the assigned transmission bandwidth.
